(19) United States
(12) Patent Application Publication
(10) Pub. No.: US 2007/0179752 A1
(43) Pub. Date: Aug. 2, 2007

(54) Communication apparatus and data protecting method of a communication apparatus

(75) Inventors: Kenichi Tonouchi, Ome-shi (JP); Kei Takahashi, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/657,875

(22) Filed: Jan. 24, 2007

(30) Foreign Application Priority Data
Jan. 31, 2006 (JP) 2006-022944

(51) Int. Cl. G06F 11/00

(52) U.S. Cl. 702/188

(57) ABSTRACT

According to one embodiment, a communication apparatus which performs a wireless communication based on a wireless universal serial bus (USB), includes a monitoring unit configured to monitor a wireless connection situation to and from a partner being in progress of data transfer, and a data protecting unit configured to execute data protection processing to protect the data transmitted and received to and from the partner when the monitoring unit detects a situation in which a wireless connection to the partner is potentially and abnormally disconnected during the data transfer.

### CROSS-REFERENCE TO RELATED APPLICATIONS

This application is based upon and claims the benefit of priority from Japanese Patent Application No. 2006-022944, filed Jan. 31, 2006, the entire contents of which are incorporated herein by reference.

### BACKGROUND

1. Field

One embodiment of the invention relates to a communication apparatus and a data protecting method appropriate to apply a personal computer to which a peripheral device such as a hard disk drive is connected wirelessly.

2. Description of the Related Art

In recent years, a notebook-type personal computer possible to be battery-driven and easy to be carried has been widely used. On the one hand, such type of a portable computer requires providing reduced size in mind the use, for example, in a trip destination or during movement, and on the other hand, it strongly requires providing easiness of an expansion such as hot swapping and plug-and-play in mind the use at an office or home.

A universal serial bus (USB) having been widely used as one of standards to connect a peripheral device such as a hard disk drive and a digital versatile disk drive with a large capacity if necessary, recently, further more, adoption of a wireless USB that is one of application techniques of ultra wideband (UWB) has been beginning to be examined in order to enable easily connecting the peripheral appliance wirelessly.

In comparison with a cable communication transmitting/receiving data via a cable, a wireless communication is easily influenced by environments at each occasion, and has to take an accidental disconnection into account. Therefore, various methods related to avoidance of the disconnection and countermeasure in the disconnection have been proposed (for example, refer to Jpn. Pat. Appln. KOKAI Publication No. 2004-228851).

By the way, the wireless USB is one in which the existing USB 2.0 is expanded, and the USB 2.0 uses the cable communication, so that the possibility of the accidental disconnection has remained as it is without being taken into account. However, as mentioned above, the wireless communication being easily influenced by the environments at each time, it is absolutely necessary to give consideration to the accidental disconnection.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view illustrating a construction of a wireless network by means of a personal computer to which a communication apparatus regarding an embodiment of the invention is applied;

FIG. 2 is an exemplary functional block diagram of a wireless USB (WUSB) owned by the personal computer of the embodiment; and

FIG. 3 is an exemplary flowchart illustrating operation procedures relating to data protection control during a wireless communication of the personal computer of the embodiment.

### DETAILED DESCRIPTION

Various embodiments according to the invention will be described hereinafter with reference to the accompanying drawings. In general, according to one embodiment of the invention, A communication apparatus which performs a wireless communication based on a wireless universal serial bus (USB), includes a monitoring unit configured to monitor a wireless connection situation to and from a partner being in progress of data transfer, and a data protecting unit configured to execute data protection processing to protect the data transmitted and received to and from the partner when the monitoring unit detects a situation in which a wireless connection to the partner is potentially and abnormally disconnected during the data transfer.

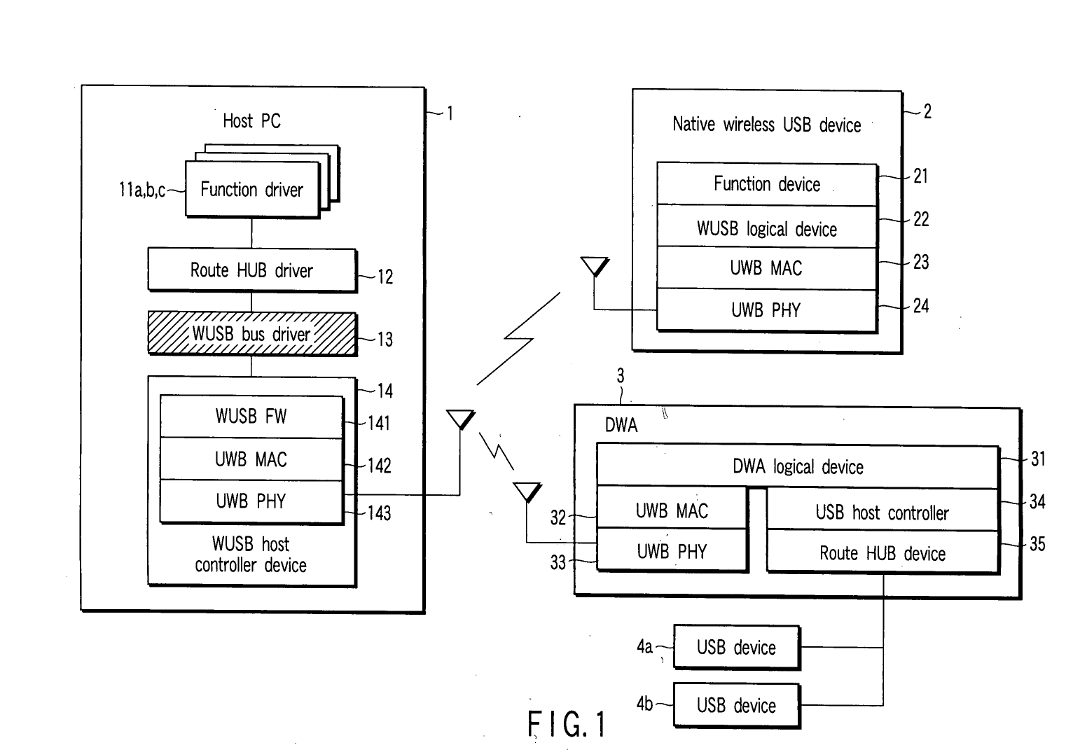

FIG. 1 is an illustration showing one construction example of a wireless network by a personal computer (host PC 1) to which a communication apparatus of the embodiment is applied.

The host PC 1 executes a wireless communication based on wireless USB (hereinafter referred to as WUSB) standards with a native wireless USB device 2 and a device wire adaptor (DWA). The native WUSB device means a device to be directly and wirelessly connected to the host PC 1, and it is named in order to distinguish from USB devices 4a, and 4b indirectly connected to the host PC 1 via a DWA 3.

The DWA 3, for example, mediates a data transmission/reception among the existing USB devices 4a and 4b performing cable communications compliant with the USB 2.0 standards and the host PC 1 performing wireless communications compliant with the WUSB standards. The DWA 3 has a cable downstream port (DSP) to cable-connects the USB devices 4a and 4b.

As shown in FIG. 1, the host PC 1 includes function drivers 11a-11c, a route HUB driver 12, a WUSB bus driver 13 and a WUSB host controller device 14. The controller device 14 has a WUSB FW 141, a USB MAC 142 and a UWB PHY 143.

The function drivers 11a-11c are started one by one at every time when USB devices are connected to the host PC 1. Here, three USB devices, namely, the native WUSB device 2, and USB devices 4a and 4b being connected, three function drivers 11a-11c exist by making each pair with the three USB devices.

Requests relating to wireless communication processing from the function drivers 11a-11c that are drivers to control each USB device are transferred to the WUSB bus driver 13 through the HUB driver 12. The WUSB bus driver 13 drive-controls the controller device 14 in order to execute the wireless communication processing indicated by the request received from the HUB driver 12.

The WUSB FW 141 is firmware to control the whole of the controller device 14, and executes transmissions of transmission data to wireless communication paths via the UWB MAC 142 and UWB PHY 143, and taking in reception data from the communication paths via the UWB PHY 143 and UWB MAC 142 under the control by the WUSB FW 141.

The native WUSB device 2 includes a function device 21, a WUSB logical device 22, a UWB MAC 23 and a UWB PHY 24. The function device 21 is a module to operate by being controlled from any one of the function drivers 11a-11c of the host PC 1. The WUSB logical device 22, UWB MAC 23 and UWB PHY 24 has functions corresponding to the WUSB FW 141, UWB MAC 142 and UWB PHY 143 of the host PC 1, respectively.

The DWA 3 includes a DWA logical device 31, a UWB MAC 32, UWB PHY 33, a USB host controller 34 and a route HUB device 35. The DWA logical device 31, the UWB MAC 32 and UWB PHY 33 among the foregoing included components has functions corresponding to the WUSB FW 141, UWB MAC 142 and UWB PHY 143 of the host PC 1, respectively. The host controller 34 and HUB device 35 other than these components perform the cable communications compliant with the USB 2.0 standards to and from the USB devices 4a and 4b connected with cables.

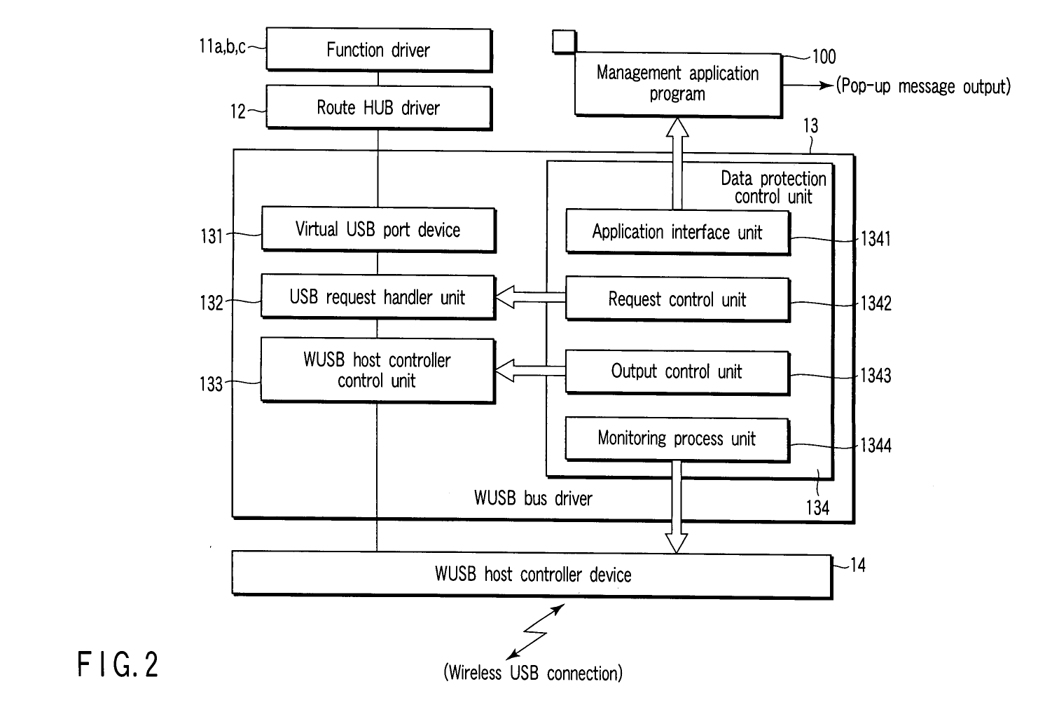

As described above, the wireless communications based on the WUSB standards is performed among the host PC 1, the native WUSB device 2 and the DWA 3. Accordingly, the wireless communications are apt to be influenced by the environments at each time. Therefore, in the host PC 1 of the embodiment managing the whole of the communications in this wireless network, the WUSB bus driver 13 executes disconnection avoidance or data protection control not to cause a loss of data due to an accidental disconnection. FIG. 2 is an exemplary functional block diagram of the WUSB bus driver 13 of the host PC 1.

As shown in FIG. 2, the WUSB bus driver 13 comprises a virtual USB port device 131, a USB request handler unit 132, a WUSB host controller control unit 133 and a data protection control unit 134. The requests from the HUB driver 12 are taken in through the port device 131 to be supplied to the handler unit 132. The handler unit 132 has a function of queuing to suspend the requests or of releasing it in addition to a function of relaying the requests to the host controller control unit 133 in the descending order of the priority. The host controller control unit 133 then drive-controls the controller device 14 so as to conduct the wireless communication processing shown by the input requests, and it has a function to instruct an increase/decrease in a transmission output to the host controller device 14. When receiving the instruction, the host controller device 14 transmits control information to require an increase/decrease in transmission output toward its own direction to a specific wireless communication partner as well as increases/decreases the transmission output.

The protection control unit 134 performs data protection control so as not to lose the data transmitted/received through the wireless communication cooperatively executed by the port device 131, handler unit 132, and the host controller control unit 133 even if the wireless connection is disconnected. Therefore, the protection control unit 134 comprises an application interface unit 1341, a request control unit 1342, an output control unit 1343 and a monitoring process unit 1344.

The process unit 1344 periodically collects information such as a received signal strength indication (RSSI) and a link quality indication (LQI) from the host controller device 14 to monitor whether the values of the collected information go within a preset threshold. When it is detected for a radio signal state to be not larger than the threshold by monitoring through the process unit 1344, the output control unit 1343 notifies for the host controller control unit 133 to increase the transmission output. In contrast, in the case of being not smaller than the threshold, the output control unit 1343 notifies to the host controller control unit 133 to decrease the transmission output.

When the radio signal state becomes not larger than the threshold, the request control unit 1342 notifies to the request handler unit 132 so as to suspend control transactions and bulk transactions potentially influenced by abnormal disconnections and to protect the data among the requests from the function drivers 11a-11c ranked higher. Further, if the state of being not larger than the threshold has continued for a period not shorter than a fixed one, the request control unit 1342 brings the suspended requests into erroneous completions, and also notifies the fact to the request handler unit 132 so as not to accept a new request. When the state returns to a state of being not smaller than the threshold within a fixed period, the request control unit 1342 notifies to the request handler unit 132 so as to restart the processing of the requests made suspended.

The application interface unit 1341 is an interface unit to and from a management application program 100 displaying, for instance, a pop-up message. If the radio signal state becomes not larger than the threshold, the interface unit 1341 makes a notification to the program 100 so as to display the pop-up message for notifying the fact of the decrease to a user.

That is, to perform the wireless communication based on the wireless USB standards, the host PC 1 of the embodiment periodically collects the information, such as a RSSI and a LQI, to monitor the radio signal state being in progress of data transfer, and on the basis of the monitoring result, the control for the data protection resulting in implementation is:

(1) Notifying the fact, to the user through the pop-up message, that the wireless communication is in a state that there is probability of the disconnection of the wireless connection

(2) Blocking (queuing) the control transactions and bulk transactions which have probabilities to be influenced by abnormal disconnections

(3) Restarting processing which has blocked if the radio signal state returns within the threshold

(4) Making the processing which has been blocked be an erroneous completion and preventing from accepting the later requests after notifying the fact to the user through the pup-up message when the radio signal state does not return after the lapse of the fixed period.

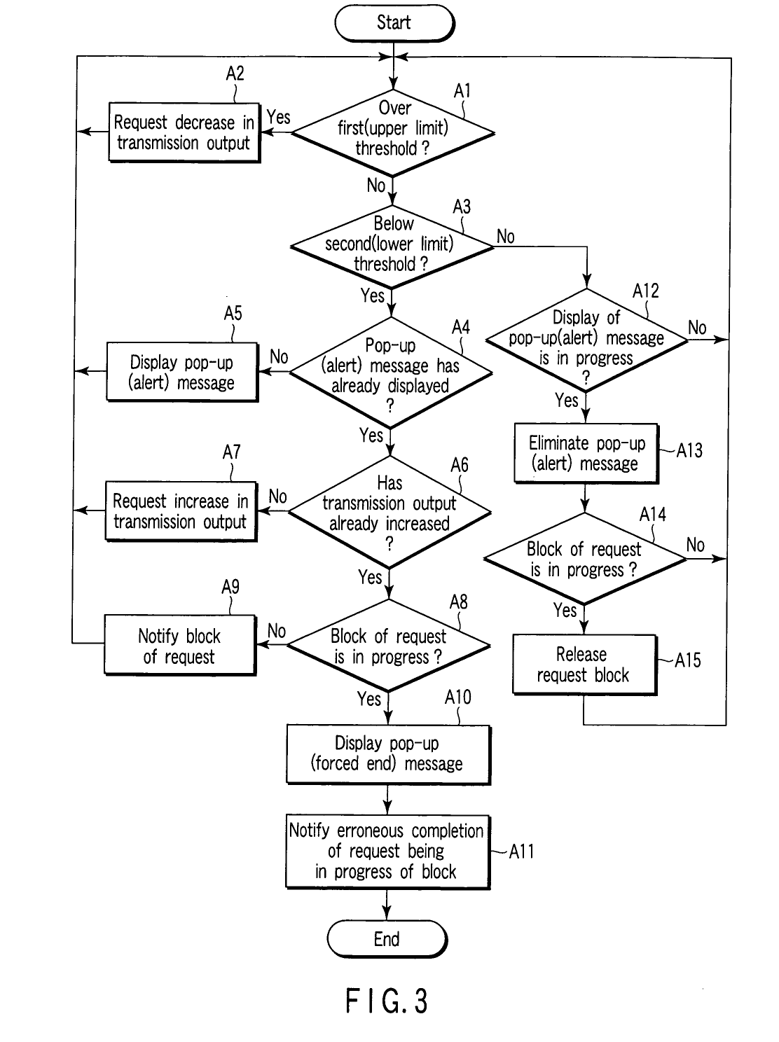

FIG. 3 is an exemplary flowchart illustrating operation procedures related to the data protection control when the host PC 1 performs the wireless communication.

The monitoring process unit 1344 periodically collets information such as a RSSI and a LQI from the host controller device 14 and monitors them. If the values of the collected information are larger than a first threshold on an upper limit side (Yes, in block A1), the output control unit 1343 notifies a request for a decrease in the transmission output to the host controller control unit 133 (block A2).

In contrast, if the values of the collected information are smaller than a second threshold on a lower limit side (No, in block A1, Yes, in block A3), at first, it is checked whether or not a pop-up message to alarm the fact, that the wireless communication is in a radio signal state that there is a probability of a disconnection of the wireless connection, has already been displayed (block A4). Then, if the message has not been displayed yet (No, in block A4), the interface unit 1341 notifies the display of the pop-up message to the program 100 (block A5).

If the pop-up message has already been displayed (Yes, in block A4), next to this, it is checked whether or not the transmission output has already increased (block A6). If the output has not increased yet (No, block A6), the output control unit 1343 requests an increase in transmission output to the host controller control unit 133 (block A7).

Further, if the transmission output has already increased (Yes, in block A6), it is determined whether the request block is in progress or not (block A8), and if the request has not been blocked (No, in block A8), the request control unit 1342 notifies (requests) request block to the request handler unit 132 (block A9).

If the request block has been in progress (Yes, in block A8), the interface unit 1341 notifies the display of the pop-up message to notify the forced end of the wireless communication to the program 100 (block A10), and also the request control unit 1342 notifies the erroneous completion of the blocked request to the USB request handler unit 132 (block A11).

In contrast, if the values of the information collected through the process unit 1344 are not over the first threshold on the upper limit side, and also are not below the second threshold on the lower limit side (No, in block A1, No in block A3), if the pop-up message for an alarm is in the middle of displaying (Yes, block A12), its disappearing is notified from the interface unit 1341 to the program 100 (block A13). If the request is in the middle of blocking (Yes, in block A14), its release is notified from the interface unit 1341 to the program 100 (block A15).

In this way, according to the host PC 1 of the embodiment, to execute the wireless communication based on the wireless USB standards, the data protection control not to lose the data due to accidental disconnection results in appropriate implementation.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus which performs a wireless communication based on a wireless universal serial bus (USB), comprising:
a monitoring unit configured to monitor a wireless connection situation to and from a partner being in progress of data transfer; and
a data protecting unit configured to execute data protection processing to protect the data transmitted and received to and from the partner when the monitoring unit detects a situation in which a wireless connection to the partner is potentially and abnormally disconnected during the data transfer.

2. The communication apparatus according to claim 1, wherein the data protecting unit outputs a message to notify the fact that there is the situation in which the wireless connection is potentially and abnormally disconnected during the data transfer.

3. The communication apparatus according to claim 1, wherein the data protecting unit queues to suspend processing related to data transfer potentially affected when the wireless connection is abnormally disconnected.

4. The communication apparatus according to claim 3, wherein the data protecting unit releases the suspension by the queuing when the situation, in which the wireless connection is potentially and abnormally disconnected during the data transfer, is eliminated.

5. The communication apparatus according to claim 3, wherein the data protecting unit brings the processing suspended by the queuing into an erroneous completion when the situation, in which the wireless connection is potentially and abnormally disconnected during the data transfer, continues over a fixed period.

6. The communication apparatus according to claim 1, wherein the monitoring unit monitors a received signal strength indication (RSSI).

7. The communication apparatus according to claim 1, wherein the monitoring unit monitors a link quality indication (LQI).

8. A data protecting method of a communication apparatus which performs a wireless communication based on a wireless universal serial bus (USB), comprising;
monitoring a wireless connection situation to and from a partner being in progress of data transfer; and
executing data protection processing to protect data transmitted and received to and from the partner when the monitoring detects a situation in which a wireless connection to the partner is potentially and abnormally disconnected during the data transfer.

9. The data protecting method according to claim 8, wherein the executing data protecting processing outputs a message to notify the fact that there is the situation in which the wireless connection is potentially and abnormally disconnected during the data transfer.

10. The data protecting method according to claim 8, wherein the executing data protection processing queues to suspend processing related to data transfer potentially affected when the wireless connection is abnormally disconnected

11. The data protecting method according to claim 10, wherein the executing data protection processing releases the suspension by the queuing when the situation, in which the wireless connection is potentially and abnormally disconnected during the data transfer, is eliminated.

12. The data protecting method according to claim 10, wherein the executing data protection processing brings the processing suspended by the queuing into an erroneous completion when the situation, in which the wireless connection is potentially and abnormally disconnected during the data transfer, continues over a fixed period.
